(19) United States
(12) Patent Application Publication
(10) Pub. No.: US 2010/0299735 A1
(43) Pub. Date: Nov. 25, 2010

(54) Uniform Resource Locator Redirection

(76) Inventor: Wei Jiang, Redmond, WA (US)

Correspondence Address: MICROSOFT CORPORATION, ONE MICROSOFT WAY, REDMOND, WA, 98052, US

(21) Appl. No.: 12/468,705

(22) Filed: May 19, 2009

(51) Int. Cl. G06F 15/16; H04L 9/32; G06F 21/00; G06F 17/30

(52) U.S. Cl. 726/7; 709/229; 726/9; 707/E17.044

(57) ABSTRACT

Uniform resource locator (URL) redirection techniques are described. In an implementation, a web browser is redirected from a URL that is blocked to a URL for a web page configured to request authorization to access the URL that is blocked. Selection is accepted of how to request authorization to access the URL that is blocked.

### BACKGROUND

Web browsers (browsers) are capable of accessing a wide variety of web pages by using uniform resource locators (URLs) that reference the web pages. Although browsers have the capability to access web pages containing content, at times a user may want to control which web pages another user may access. For example, a parent may want to restrict a child from accessing a web page including content deemed inappropriate for the child's maturity level.

Traditionally, tasks to control browser access to web pages were often tedious and time consuming as new web pages are routinely added to networks, such as the Internet. Blocking web pages that are not pre-approved, for example, may also block web pages that have been recently added or that, as of yet, have not been approved.

### SUMMARY

Uniform resource locator (URL) redirection techniques are described. In an implementation, a web browser is redirected from a URL that is blocked to a URL for a web page that includes a plurality of selections. Each of the selections describes how to request authorization to access the URL that is blocked. An input of one of the selections is received.

In an implementation, one or more computer-readable media comprise instructions that are executable to provide a user interface (UI) to request authorization to access a URL that is blocked. The UI is provided in response to receipt of an input that selects one or more of a plurality of selection. Each of the selections describes how to request authorization to access the URL that is blocked. The instructions are further executable to cause a service that is accessible via a network to communicate a token that is usable to add the URL to a list of URLs which the user is authorized to access.

In an implementation, one or more computer-readable media comprise instructions that are executable to provide a web page configured to accept a selection that specifies how to request authorization to access a URL. The web page is provided in response to an attempt by a web browser to access a uniform resource locator. A token is returned to a computer that includes the web browser in response to a determination that authorization has been received. The token is usable by the computer to add the URL to a list of URLs to which access is authorized.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to perform uniform resource locator (URL) redirection.

FIG. 2 is an illustration of a system in an example implementation showing implementation of the filter module of FIG. 1 to accept selection of how to request authorization to access a blocked URL.

FIG. 3 is an illustration of a web page configured to accept selection of how to request authorization to access a blocked URL.

FIG. 4 is an illustration of a system in an example implementation showing implementation of the filter module of FIG. 1 to accept authorization.

FIG. 5 is an illustration of a system in an example implementation showing implementation of the filter module of FIG. 1 to accept selection of how a request authorization to access a web page that provides content for another web page.

FIG. 6 is a flow diagram depicting a procedure in an example implementation that is used to select how to request authorization to access a blocked URL.

FIG. 7 is a flow diagram depicting a procedure in an example implementation used to accept authorization.

FIG. 8 is a flow diagram depicting a procedure in an example implementation that uses an electronic message to request authorization to access a blocked URL.

### DETAILED DESCRIPTION

Overview

Uniform resource locators (URLs) are used to direct a browser to a web page referenced by the URL. To ensure that a user, such as a child, may not access web pages that are not authorized, software may be used to block URLs which have not been approved by an entity (e.g., a parent) authorized to grant access. Consequently, the child may be blocked from a URL when the URL is new or the entity has not had an opportunity to authorize access.

URL redirection techniques are described to redirect a web browser from a URL that is blocked to a web page that includes a UI configured to accept a selection of how to request authorization. In this way, a child who is blocked may select how the request for authorization is placed from a plurality of selections. Each of the selections describe how to request authorization to access the blocked URL. For instance, a child may select to have the UI provide one or more dialog boxes so a parent may enter credentials, such as a name and password. In another instance, the child may select to send the request via an electronic message (e.g., email, instant messaging), and so forth.

In the following discussion, an example environment and systems are first described that are operable to employ URL redirection. Example procedures are then described that may be implemented using the example environment as well as other environments. Accordingly, implementation of the procedures is not limited to the environment and the environment is not limited to implementation of the procedures.

Example Environment

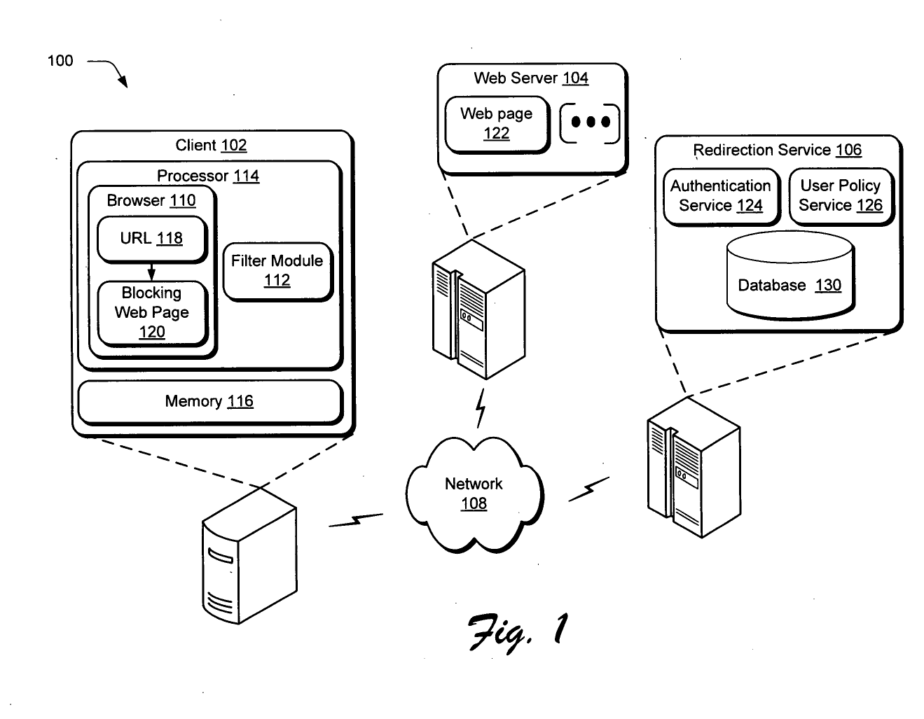

FIG. 1 depicts an environment 100 in an example implementation that is operable to employ uniform resource locator (URL) redirection. The illustrated environment 100 includes a client 102, a web page source (illustrated as a web server 104), and a redirection service 106 that are communicatively coupled via a network 108.

In the following discussion, the client 102, the redirection service 106, and the network 108 may be representative of one or more devices. For example, the client 102 may represent multiple clients of the redirection service 106. At times in the discussion, functions performed by devices in the environment 100 are described with respect to services, modules, and so on. The services and modules may be arranged in a variety of ways and the described functions may be performed by a single module, performed by sub-modules, performed by a combination of modules, and so forth.

As illustrated, the client 102 includes a web browser (browser 110), and a filter module 112 that are configured to execute on one or more processors (illustrated as a processor 114). The processor 114 may be configured to provide modules that may be stored in memory 116 until executed by the processor 114.

The browser 110 is representative of functionality to access web pages by using a URL that references (e.g., points to) the web page. Thus, access to the web page is blocked when access to the URL is blocked.

URLs may be selected in a variety of ways. For example, a user may type the URL into the browser 110. A user may also access a web page by selecting (e.g., clicking) on a link that contains the URL.

In some implementations, the browser 110 may access a web page referenced by a URL in a second web page to obtain data forming content for the second web page. In this way, the second web page may provide content without storing the content on a web server for the second web page.

The filter module 112 is representative of functionality to control which web pages the browser 110 may access. To do this, the filter module 112 may redirect the browser 110 from a URL that is blocked 118 to a web page that is configured for use in requesting authorization to access the blocked URL (illustrated as “blocking web page” 120).

In some instances, the browser 110 is redirected via a 302 response, such as to a different web page than was requested. For example, the filter module 112 may redirect the browser 110 by checking the URL with the redirection service 106, a list of URLs that is maintained locally on the client 102, and so on. For instance, the filter module 112 may check the requested URL with a list of authorized URLs to determine whether access to the URL, and therefore the referenced web page, is authorized.

The filter module 112 may also determine whether access is authorized based on a user that placed the request. For instance, an operating system (OS) used to control the client 102 may provide an identity of a user to the filter module 112, e.g., which user is logged-in. Thus, the filter module 112 may permit access according to which user is logged into the client 102.

Although operation of the filter module 112 is described with respect to the browser 110, the filter module 112 may be incorporated by a variety of web-enabled applications. For example, the filter module 112 may control access for a web-enabled word processing application.

The client 102 may be a variety of devices, such as a personal computer, a mobile computing device, a smart phone, a laptop, and so on. The client 102 may be configured with limited functionality (e.g., a thin device) or with robust functionality, e.g., a thick device. A device's functionality may relate to the device's software or hardware resources, e.g., processing power, memory (e.g., data storage capability), and so on.

The web server 104 is representative of functionality to provide data to form one or more web pages referenced by URLs. For example, the web server 104 may communicate data to form a web page in response to a request from the browser 110. At times, the web server 104 may be configured to obtain data from other web servers in order to provide a web page 122. For example, the web server 104 may obtain data from another web server to provide content on the web page 122.

As illustrated, the redirection service 106 includes an authentication service 124 and a user policy service 126. The filter module 112 may use the redirection service 106 as part of redirecting the browser 110 from a URL that is blocked 118 to a URL for a web page 120 that is configured to request authorization to access the URL that is blocked.

A database 130 is also included in the redirection service 106. The database 130 may be used to store data associated with authenticating entities and/or redirecting browsers, e.g., store URLs that are blocked for a particular user.

The authentication service 124 may be used to authenticate an entity's identity. In an implementation, the filter module 112 verifies an entity's identity by sending the authentication service 124 a name (e.g., user name) and a password for authentication. In this way, the authentication service 124 may validate that the parent is “who they say they are.” The authentication service 124 in conjunction with the user policy service verifies that the entity is authorized to grant access to the URL.

By using the authentication service available via the network 108, the entity's identity may be authenticated without physically interacting directly with the client 102. Thus, a parent may use a smart phone to authorize a child's browser access to a URL. Although a separate device may be used, the parent may also enter a name and password via the browser 110 on the client 102, e.g., an “over-the-shoulder” authorization.

The user policy service 126 is representative of functionality to determine whether access to a URL is authorized for the user. The filter module 112 may also implement the user policy service 126 to determine whether the browser 110 is authorized to access a URL.

The user policy service 126 stores URLs that the user is authorized to access in the database 130. For example, the URLs in the database 130 may correspond to the URL in the list on the client 102. The database 130 may store URLs that are blocked in place of, or in addition to, authorized URLs.

In further instances, the user policy service 126 is configured to heuristically determine whether access to a URL is permitted. For example, the user policy service 126 may use heuristic techniques to determine whether to block access to a new URL based on URLs that are blocked and/or URLs to which access has been permitted.

As illustrated in FIG. 1, the client 102, the web server 104, and the redirection service 106 communicate via the network 108. Although the network 108 is illustrated as the Internet, the network 108 may assume a wide variety of configurations. For example, the network 108 may include a wide area network (WAN), a local area network (LAN), a wireless network, a public telephone network, an intranet, and so on. Further, although a single network is shown, the network 108 may be configured to include multiple networks.

Generally, any of the functions described herein can be implemented using software, firmware, hardware (e.g., fixed logic circuitry), manual processing, or a combination of these implementations. The terms “module,” “functionality,” “service,” and “logic” as used herein generally represent software, firmware, hardware, or a combination of software, firmware, or hardware. In the case of a software implementation, the module, functionality, service, or logic represents program code that performs specified tasks when executed on a processor (e.g., CPU or CPUs). The program code can be stored in one or more computer readable memory devices (e.g., one or more tangible media), and so on. The structures, functions, approaches, and techniques described herein may be implemented on a variety of commercial computing platforms having a variety of processors.

Processors used to execute software in software implantations are not limited by the materials from which they are formed or the processing mechanisms employed therein. For example, processors may be comprised of semiconductor(s) and/or transistors, e.g., electronic integrated circuits (ICs). Having discussed the environment 100, sample systems are now described.

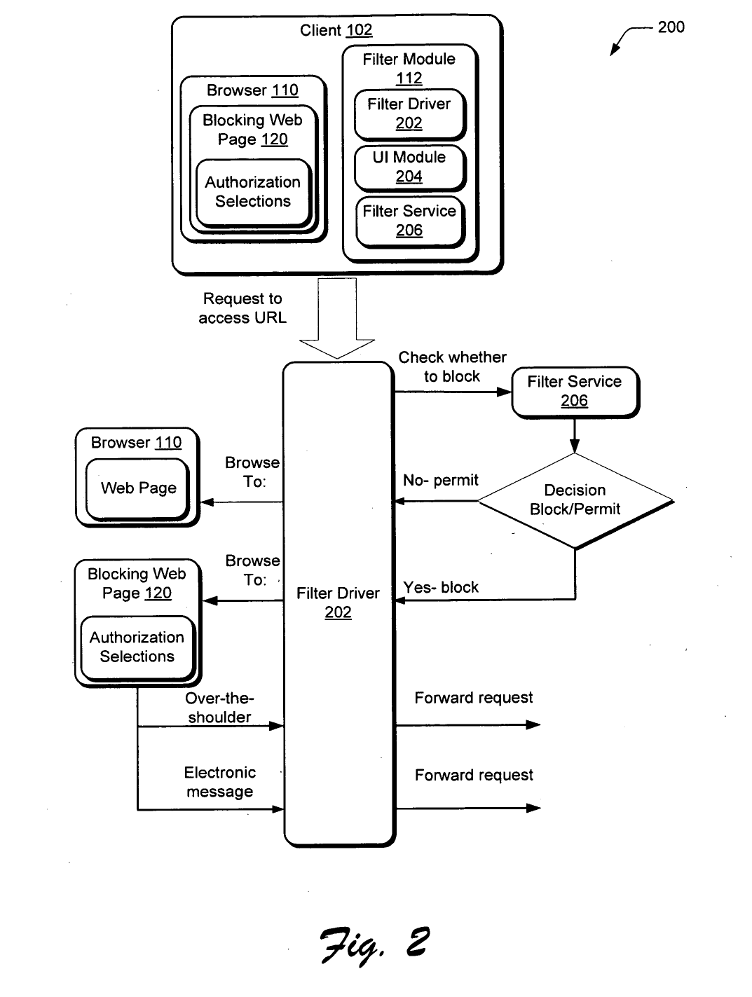

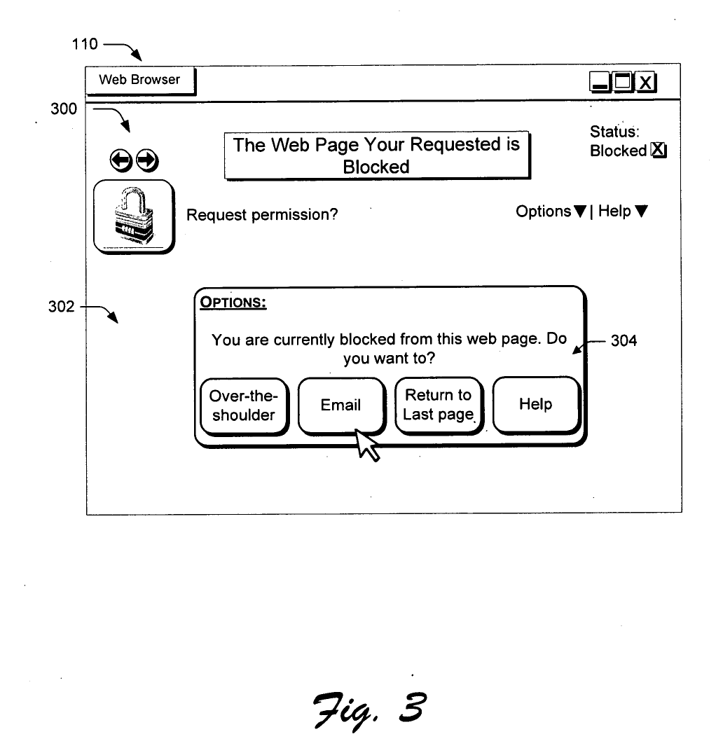

FIG. 2 depicts a system 200 in an example implementation illustrating operation of the filter module 112 in further detail. In addition, sample data flows, approaches, techniques, structures, and operation of various entities are also illustrated. FIG. 3 is described in conjunction with FIG. 2. FIG. 3 illustrates an example web page 300 to which the browser 110 may be redirected. As shown, the web page 300 provides a UI 302 configured to receive an input that selects how a request for authorization is obtained.

As shown in FIG. 2, the filer module 112 includes a filter driver 202, a UI module 204, and a filter service 206. The browser 110 is illustrated as displaying a “blocking web page” 120, an example of which is the web page 300.

The filter driver 202 is representative of functionality to provide interaction between the browser 110 and the filter service 206. The filter driver 112 is stored in memory 116 and is executable by the processor 114 to capture and communicate the URL requested by the browser 110.

The filter service 206 is representative of functionality to check whether access to the URL is authorized. The filter service 206 may also communicate with the UI module 204.

The filter service 206 is configured to check whether the URL matches a URL included in a list of URLs that is maintained locally on the client 102, e.g., in memory 116. The list of URLs includes URLs to which access is authorized and/or blocked.

In further embodiments, the filter service 206 implements the user policy service 126 to determine whether access is authorized. The foregoing may be performed in conjunction with a check of the list of URLs maintained on the client 102 or as part of a multistep process. For example, the filter module 112 may check the user policy service 126 when a requested URL is not included in the list of URLs on the client 102. In this way, a parent may authorize access even though a child changes computers.

In addition embodiments, the filter service 206 is configured to heuristically determine whether a URL is blocked. A heuristic determination may be used when a URL is neither affirmatively authorized nor blocked. The heuristic determination may be based on reviews reported by other users (e.g., parents), a rating service, previous authorization decisions, and so on.

The filter service 206 passes back a result of the check to the filter driver 202. When the URL matches a URL included in a list of URLs to which access is authorized, the filter driver 202 communicates the result to the browser 110 that outputs the referenced web page.

In contrast, the filter service 206 may also cause the filter driver 202 to redirect the browser 110 to the web page 120 with a UI (e.g., UI 302) that permits a user to select how authorization is requested from a plurality of selections. In this way, the user may select how authorization is requested, e.g., over the shoulder, instant messaging, email, and so on. Having discussed the filter module 112 an example of a blocking web page 120 is described.

Referring now to FIG. 3, an example blocking web page 300 is illustrated. The web page 300 includes buttons 302 that are used to select how authorization is requested. Example buttons include, but are not limited to, manual approval, email approval, return to last page, and help. In response to a selection of the email button, the filter service 206 may send an email to an entity authorized to grant access. The email may also include a link to a webpage configured to accept the entity's credentials.

In addition to offering a plurality of selections of how authorizations are requested, the web page 300 may also provide information regarding the redirection, e.g., notify the user that redirection has occurred. The web page 300 may also indicate whether the page is affirmatively blocked, blocked because the web page is new, and so forth.

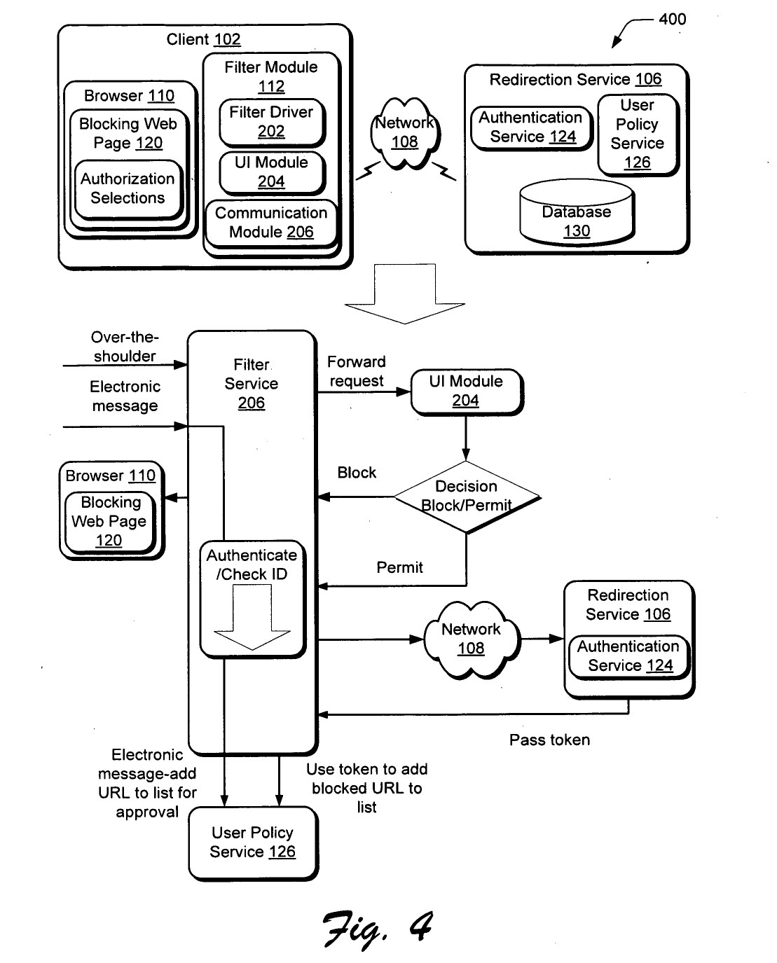

As illustrated in FIG. 4, a system 400 is operable to use redirection techniques to access a URL that is blocked. Sample data flows and operations of various services and modules are also illustrated. The system 400 may also implement the approaches, structures, described in conjunction with FIG. 2.

The filter module 112 accepts the request for authorization from the browser 110. When the user requests over-the-shoulder authorization, the filter driver 202 then passes the request (e.g. forwards the request) to the UI module 204 via the filter service 206. In response, the UI module 204 may provide a UI with a challenge. Example challenges include a request for credentials (e.g., name and password) and so on. For example, the UI may provide dialog boxes to accept a name and password.

The UI may also accept a selection to affirmatively block access to the URL. For example, the UI 302 may include a button, that when selected, affirmatively blocks access to the URL. The UI 302 may also provide information about the web page (e.g., a synopsis, a review) or preview content from the web page that is blocked.

The credentials (e.g., name and password) may be passed via the filter service 206 to the redirection service 106 for authentication (illustrated as authenticate/check ID). The name and password is compared to names and passwords stored in the database 130 to authenticate the entity's identity. The authorization service 124 then passes a token (e.g., a security token) to the filter service 206 when the name and password accepted by the UI matches those included in the database 130.

The filter service 206, in response to a successful verification, checks to see that the identity in the token matches that of an entity that is authorized to grant access. The token is used by the filter service 206 to add the URL to the list of URLs that are authorized access (e.g., maintained locally on the client 102). The access may be granted in a variety of ways. For example, the entity may authorize access for the user who requested access or a group to which the user belongs, e.g., each child in the family. The URL may also be added to the URLs stored on the database 130. In this way, the filter service 206 may filter blocked/authorized URLs locally while enabling filtering when the user changes computers.

Accordingly, in some embodiments, the redirection service 106 may be used to verify the entity's identity matches that of an entity permitted to authorize access for the user. For example, the authorization and user policy services 124, 126 may be used to authenticate the entity's identity and check whether the identity matches that of an identity authorized to grant access.

When an electronic message is used to communicate the request (e.g., user sends an email that requests access), the filter driver 202 may pass the request to the filter service 206 which adds the URL to a list of URLs for which authorization is sought. For example, the filter service 206 may communicate the request to the redirection service 106 that sends an email to a parent. The parent may use the electronic message to authorize access, e.g., by “clicking” on a link. Although authentication may be performed by collecting and checking a user name and password as described, authentication may also be avoided if the entity has self-authenticated. For example, self-authentication may occur if the entity has already logged-in to an email account.

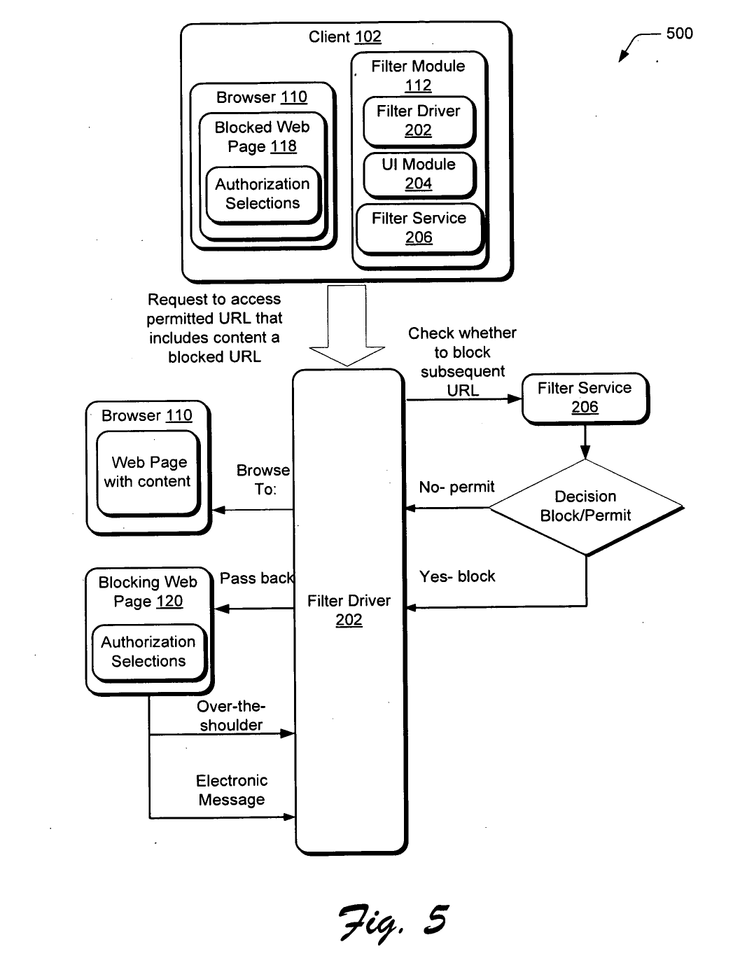

FIG. 5 depicts a system 500 in which URL redirection techniques are used to request access to a web page that provides data forming content for another web page, e.g., hidden content. In the described scenarios, access to the web page providing data forming content is blocked while access to a web page that includes the URL is permitted. For example, instead of including content on a first web page, the first web page may include a URL for a second web page that provides content (e.g., hidden content) for the first web page.

In addition to the system 500, sample data flows are also shown. The approaches, techniques, structures, and so forth may be used in combination with those previously described. For the purposes of discussion only, the user is presumed to have authorization to access the first web page (via a URL) but not have authorization to access to the second web page.

The filter driver 202 may be configured to capture the URL for the second web page when requested by the browser 110. For example, the filter driver 202 may capture the URL for the second web page in response to an attempt by the browser 110 to access and retrieve content from the second web page.

The filter service 206 may check whether the URL for the second web page matches a URL included in a list of URLs maintained on the client, e.g., locally in memory 116. Thus, filter service 206 may determine whether to block or authorize access to the URL for the second web page based on the check.

In some embodiments, the filter service 206 checks the user policy service 126 to determine whether access is authorized. For example, the user policy service 126 may be used when the URL for the second web page is not included in the list of URLs maintained on the client 102, used when the user has changed clients, and so on.

When the URL for the second web page is blocked, the filter driver 202 redirects the browser 110 to the blocking web page 120, which is used to request authorization. The redirection may be performed by issuing a 302 response by the filter driver 202. In other examples, the browser 110 may provide the first web page without the content from the second web page. A variety of other examples are also contemplated.

Example Procedures

The following discussion describes procedures that may be implemented utilizing the previously described systems, techniques, approaches, and modules. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems described above.

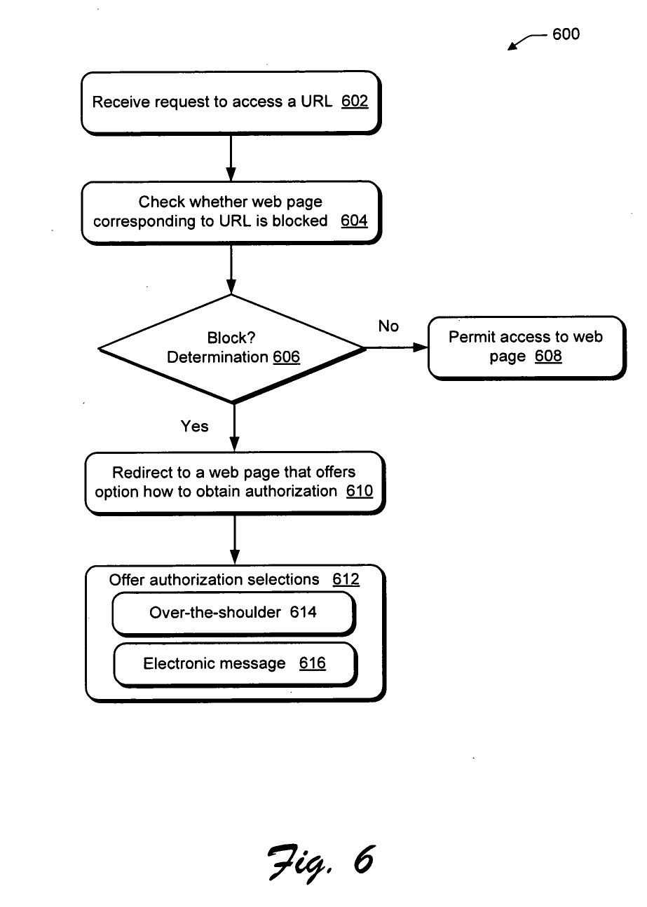

FIG. 6 depicts a procedure 600 in an example implementation in which URL redirection techniques are used to request access to a URL that is blocked. A request to access a URL is received (block 602). The request may be received as a result of a user selecting a link, the user entering the URL's address, and so forth.

A check is performed to determine whether access to the URL is authorized (block 604). The check may be performed by comparing the URL (captured as part of receiving the request) to a list of URLs to which access is authorized and/or blocked for the user. The list of URLs may be maintained locally, via a network service (e.g., the user policy service 126), and so on.

The determination (decision block 606) includes implementation of the check (block 604). When the check indicates access is granted (e.g., the check indicates the URL is not blocked), access to the URL and the referenced web page is granted (block 608).

When the determination indicates access is blocked the browser is redirected to a web page to accept selection of how to request access (block 610). Redirection may occur when the check indicates that access is not permitted, e.g., the “yes” branch is followed.

An input is accepted, via the UI included on the web page, to select how authorization is requested (block 612). The UI may offer a plurality of selections, each of which describes how to request authorization, such as over-the-shoulder, via an electronic message, and so on. For example, the UI may be used to send an electronic message that is used to request access (block 614). Electronic messages include email, instant message, and so forth. Other types of authorizations include an “over-the-shoulder authorization” (block 616), and so on. Having described redirection techniques used to request access, over-the-shoulder authorization is now described.

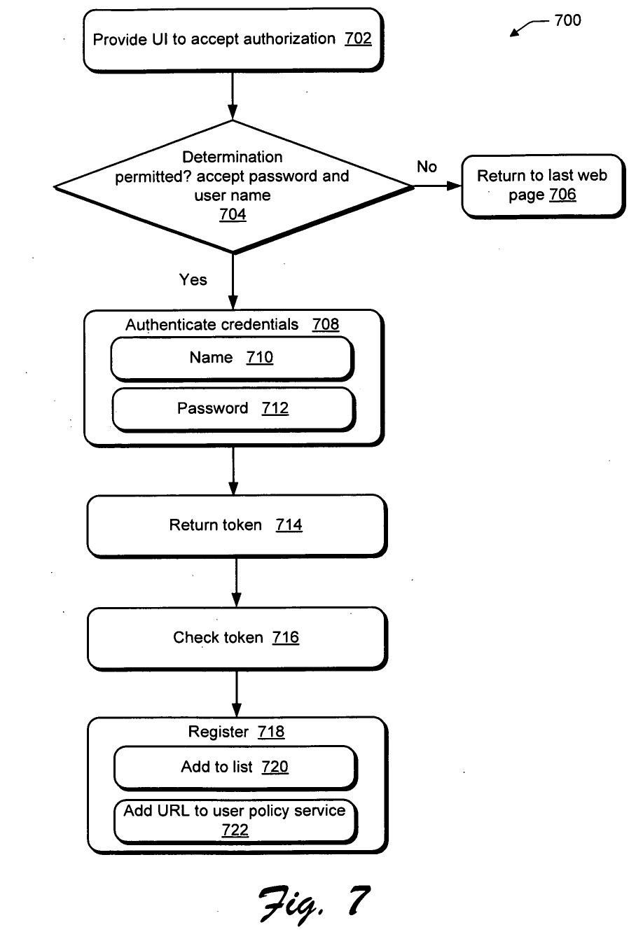

FIG. 7 depicts a procedure 700 in an example implementation in which over-the-shoulder authorization is used to request access to a URL that is blocked. The procedure 700 may be used in conjunction with the procedure 600 described above.

A UI is provided to accept authorization (block 702). For example, the browser may output a web page that includes the UI. The UI may be configured to provide a challenge for completion before access is granted. The challenge may also be configured to request credentials, such as a name and password, to authenticate the entity's identity and authorize access.

The determination (decision block 704) illustrates implementation of the UI in which authorization is accepted. The “no” branch represents a determination that the URL is to remain blocked. For instance, a parent may refuse to provide valid credentials or select a “decline” button. As a result, the browser may be directed to a web page that indicates that permission is denied, provide an indication the browser has been redirected, or may return the browser to a web page that is authorized (illustrated as return to last web page (block 706)). In contrast, the “yes” branch may be followed when an entity responds to the challenge, e.g., enters credentials.

The credentials are authenticated (block 708). For instance, the name (block 710) and password (block 712) are checked to determine the entity's identity.

A token is then returned (block 714) in response to successful authentication. In an implementation, the authentication service 124 passes a token to the filter service 206 indicating the identity of the entity. The token may also include information related to the entity's identity, and so on.

The token is checked (block 716). For example, the filter service 206 may verify that an identity included in the token matches an identity of an entity authorized to grant access to the URL. A list of entities that are authorized to grant access may be maintained locally and/or by the use policy service 126, such as by storing the blocked and/or authorized URLs in the database 130.

The token is then used to register the URL (block 718). For example, the token may be used to add the URL to a list of URLs to which access is authorized (block 720) and/or to add the URL to the user policy service (block 722). Accordingly, access to the URL may be permitted when the user next attempts to access the URL.

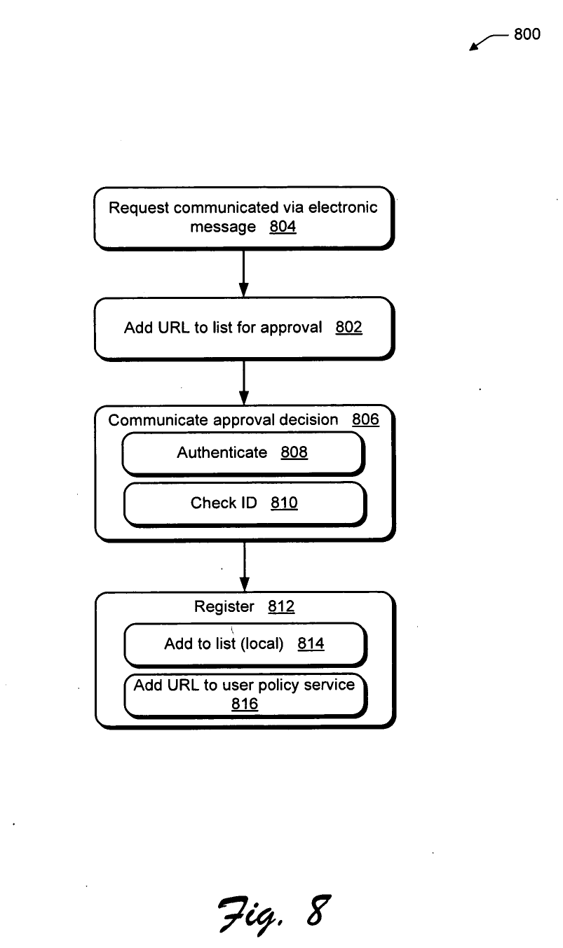

FIG. 8 depicts a procedure 800 in an example implementation in which an electronic message is used request access to a blocked URL. The procedure 800 may be used in conjunction with the procedures, approaches, systems, and procedure described above. The procedure 800 may be used when a user selects to request authorization via email.

The URL is added to a list for authorization (block 802). For instance, the URL may be added to a list for approval by a parent in response to a child sending an email requesting authorization to access the URL (block 804).

An approval decision is communicated (block 806). In an implementation, the entity may send an electronic message that is used by the filter service 206 to add the URL to a list of URL to which access is permitted. The electronic message may include or may be associated with a token that may be used to add the URL to a list of URLs to which access is authorized.

The token is used to register the URL (block 812). For example, the filter service may use the token to add the URL to a list of URL to which access is authorized (block 814). The URL may also be added by the user policy service (block 816). In some implementations, an electronic message is sent to the user that requested access and used to inform the user that access to the URL is authorized.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
redirecting a web browser from a uniform resource locator (URL) that is blocked to a URL for a web page that includes a plurality of selections, each said selection describing how to request authorization to access the URL that is blocked (610); and
receiving an input of one of the selections (612).

2. A computer-implemented method as described in claim 1, wherein the selections include an over-the-shoulder authorization or an authorization via an electronic message.

3. A computer-implemented method as described in claim 1, further comprising responsive to the receiving, providing a user interface to accept a name and a password to authorize access to the URL that is blocked.

4. A computer-implemented method as described in claim 3, further comprising:
authenticating the name and password with a service accessible via a network to determine an identity; and
using a token, received from the service, to add the URL that is blocked to a list of URLs to which access is authorized.

5. A computer-implemented method as described in claim 1, wherein the redirecting is performed locally on a computer that includes the web browser.

6. A computer-implemented method as described in claim 1, further comprising causing a service accessible via a network to add the URL that is blocked to a database if authorization is received to access the URL that is blocked.

7. A computer-implemented method as described in claim 1, wherein the URL that is blocked references a web page that provides data forming content for another web page to which access is authorized.

8. One or more computer-readable media comprising instructions that are executable to:
provide a user interface (UI) that is configured to request authorization to access a uniform resource locator (URL) that is blocked, the UI being provided in response to receipt of an input selecting one or more of a plurality of selections, each said selection describing how to request authorization to access the URL that is blocked (702);
cause a service accessible via a network to communicate a token that is usable to add the URL to a list of URLs to which access is authorized (714).

9. One or more computer-readable media as described in claim 8, wherein the list is maintained locally on a computer that executes the instructions.

10. One or more computer-readable media as described in claim 9, wherein the instructions are further executable to cause the service to store the URL in a database that includes URLs which the user is authorized to access.

11. One or more computer-readable media as described in claim 8, wherein the user interface is output for viewing by a child.

12. One or more computer-readable media as described in claim 8, wherein the URL references a web page is usable by another web page to provide data that forms content.

13. One or more computer-readable media as described in claim 8, wherein the instructions are further executable to redirect a web browser to a URL for a web page that is configured to send an electronic message to request authorization to access the URL that is blocked.

14. One or more computer-readable media comprising instructions that are executable to:
responsive to an attempt by a web browser to access a uniform resource locator (URL), provide a web page that is configured to accept a selection that specifies how to request authorization to access the URL (616); and
responsive to a determination that the authorization has been received, return a token to add the URL to a list of URLs to which access is authorized (716).

15. One or more computer-readable media as described in claim 14, wherein the instructions are further executable to add the URL to a database stored with a network service.

16. One or more computer-readable media as described in claim 14, wherein the instructions are further executable to send an electronic message that contains a link to the web page.

17. One or more computer-readable media as described in claim 14, wherein the web browser is interacted with by a child.

18. One or more computer-readable media as described in claim 14, wherein the instructions are further executable to heuristically determine whether to authorize access to the URL.

19. One or more computer-readable media as described in claim 14, wherein the instructions are further executable to send an electronic message that indicates access to the URL is authorized.

20. One or more computer-readable media as described in claim 14, wherein the instructions are further executable to perform the determination.
